(19) United States
(12) Patent Application Publication
(10) Pub. No.: US 2004/0078754 A1
(43) Pub. Date: Apr. 22, 2004

(54) Online publishing management tool and system

(76) Inventors: Jay H. Son, Fremont, CA (US); Wei Yan, Albany, CA (US)

Correspondence Address: BURNS DOANE SWECKER & MATHIS L L P, POST OFFICE BOX 1404, ALEXANDRIA, VA, 22313-1404, US

(21) Appl. No.: 10/685,906

(22) Filed: Oct. 14, 2003

Related U.S. Application Data
(63) Continuation-in-part of application No. 10/600,271, filed on Jun. 20, 2003.
(60) Provisional application No. 60/390,705, filed on Jun. 21, 2002.

(51) Int. Cl. G06F 17/00

(52) U.S. Cl. 715/501.1

(57) ABSTRACT

A system and method for creating a presentation that is published on the Internet. Image files stored on a user's computer are selected for uploading to a server computer by a user. The server computer generates and stores the presentation. Furthermore, the server computer assigns a uniform resource locator for the presentation in order to access the presentation.

### RELATED APPLICATIONS

This application is a continuation-in-part of application Ser. No. 10/600,271, filed Jun. 20, 2003. Application Ser. No. 10/600,271 claims the benefit of U.S. Provisional Application No. 60/390,705, filed Jun. 21, 2002, the entire contents of both applications are incorporated herein by reference.

### FIELD OF THE INVENTION

The present invention relates generally to Internet communications and information display systems, and more particularly to an online publishing management system for enabling an online user/client to create and publish object movies and Virtual Tours.

### BACKGROUND OF THE INVENTION

Locally based computer applications are used to create and generate lifelike interactive environments that are displayed on a computer screen. The applications generate a realistic viewing environment in order to mimic a real life experience as closely as possible for the customer. Then, in the retail environment, a customer can use the Internet based computer application to inspect products from different angles

Various systems are used to create the life-like interactive environment. These systems allow a user to create a 3DMovie or Virtual Tour (i.e. panorama) of the object of interest. The 3DMovie is a series of images of an object or objects captured from multiple angles. The images are self-running in succession by a single interface on a customer's computer. The images are formed by having the object stationary and the camera changing position in a circular pattern or by having the camera remain stationary while the object is rotated on its central axis while the images are taken. By displaying the images in quick succession, the images appear to be a movie showing the object on the computer screen.

A Virtual Tour is a panoramic image which can typically span 360 degrees. The Virtual Tour is generated from a series of images which are stitched together to form the completed view. A user can rotate the viewing angle within the Virtual Tour in order to see a full 360 degrees. Either the 3DMovie or Virtual Tour allow a user to see the object of interest from any desired view. The user can pan the image in order to see desired details.

A designer can use a locally based application to create the 3DMovie and/or Virtual Tour. One such application is described in Applicant's pending U.S. patent application entitled “SYSTEM AND METHOD FOR WEB PRESENTATION UTILIZING VOICE, VOICE-OVER, TEXT, STREAMING IMAGES AND ESCORTED BROWSING, IN REAL TIME” Ser. No. 10/085,828, filed Feb. 27, 2002, the contents of which are incorporated herein by reference. Once the 3DMovie or Virtual Tour has been created, it must be stored on a computer server and accessed by an associated URL in order for viewers to access and view the images.

Accordingly, there is a need for an online publishing and management system for 3DMovies and Virtual Tours which facilitate the creation and publication of such interactive environments. The system of the present invention publishes movies and Virtual Tours on the Internet thereby easing the creation thereof.

### SUMMARY OF THE INVENTION

In accordance with the present invention, there is a system and method for creating presentations that are published on the Internet. Image files stored on a user's computer are selected by the user. The image files are uploaded to a server computer from the user's computer. The server computer configures the image files to specifications prescribed by the user. A presentation that is viewable from a web page is generated by the server computer from the image files selected by the user. The presentation is stored on the server computer and is assigned a uniform resource locator for accessing the presentation. Furthermore, the server computer assigns a unique identification number to the presentation that the user can use to access and edit the presentation at a later time. For example, it is possible for the user to edit the presentation to add audio files that are played when the presentation is played.

The presentation can be either a 3DMovie or a Virtual Tour. The image files are configured to image height specifications selected by the user and set to consistent sizes. Furthermore, the server computer can compress the image files after configuring the image files to the user's specifications. The server computer can insert sequence numbers into the image files if the presentation is a 3DMovie or stitch the image files into a panoramic image if the presentation is a Virtual Tour.

### BRIEF DESCRIPTION OF THE DRAWING FIGURES

These, as well as other features of the present invention, will become more apparent upon reference to the drawings wherein:

FIG. 1 is a block diagram illustrating a prior an system for creating Virtual Tours and 3DMovies;

FIG. 2 is a block diagram illustrating a system for creating and publishing Virtual Tours and 3DMovies in accordance with the present invention;

FIG. 3 is a block diagram illustrating how a 3DMovie (object movie) is published in accordance with the present invention;

FIG. 4 is a block diagram illustrating how Virtual Tours are modified;

FIG. 5 is a block diagram illustrating how music can be added to a 3DMovie;

FIG. 6 is a block diagram illustrating how music can be added to a Virtual Tour;

FIG. 7 is a block diagram illustrating how a Virtual Tour is published in accordance with the present invention;

FIGS. 8 and 9 are block diagrams illustrating the applications used to publish and view 3DMovies and Virtual Tours;

FIGS. 10-40 are examples of screenshots illustrating operation of the publishing system of the present invention;

FIG. 41 is a block diagram illustrating how user access to the publishing system of the present invention is created and modified; and

FIG. 42 is a sample tree diagram showing a directory structure used with the publishing system of the present invention;

FIG. 43 is a flowchart illustrating how a 3DMovie is created;

FIG. 44 is a flowchart illustrating how narration may be added to a presentation; and

FIG. 45 is a flowchart illustrating how a Virtual Tour is created.

### DETAILED DESCRIPTION OF THE INVENTION

Referring now to the drawings wherein the showings are for purposes of illustrating a preferred embodiment of the present invention only, and not for purposes of limiting the same, FIG. 1 illustrates a prior art system 10 for creating 3DMovies and Virtual Tours that are displayed by a computer. The system 10 allows a designer to create 3DMovies and Virtual Tours using computer 12. Image stitching software 14 is installed on computer 12 and is used to create the Virtual Tours from still images. Similarly, image compiling software 16 is installed on the computer 12 and is used to make 3DMovies from a series of still images. The local computer 12 creates the 3DMovies and/or Virtual Tours which are viewed thereon. However, the software 14 and 16 does not provide a way to publish the finished projects (i.e., 3DMovies or Virtual Tours) to the Internet, generate the necessary URL's (Uniform Resource Locator), or host and manage accessibility to the projects.

As previously mentioned, once the 3DMovie or Virtual Tour has been created, it needs to be published to the Internet so that customers can have the opportunity to view it. Typically, the designer who has created the 3DMovie or Virtual Tour publishes the project by uploading it onto a web server (i.e., host) with a URL accessible to users. The designer of the project has to have knowledge about Internet publishing in order to allow customer access to the project.

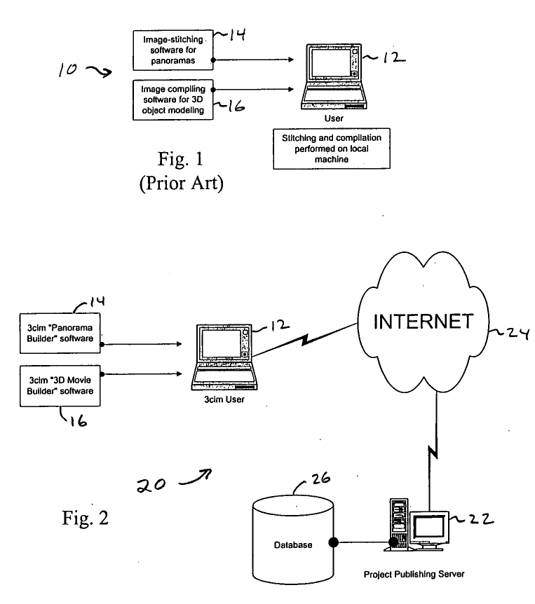

Referring to FIG. 2, a publishing system 20 is shown. The system 20 has a local machine 12 with or without the image stitching software 14 and image compiling software 16 installed thereon for creating the Virtual Tour and 3DMovie projects. The system 20 includes a project publishing server 22 which can also perform a variation of the stitching and compiling processes and which is connected to the local computer 12 via the Internet 24. The project publishing server 22 of the system 20 has a database 26 for storing and managing completed projects. As will be further explained below, the project publishing server 22, as well as the database 26, provide the tools for online publishing, data and account management, and generation of URL's for public viewing of the projects. In this regard, the project publishing server 22 and database 26 can host a designer's project and provide the necessary tools to manage and allow access to such project.

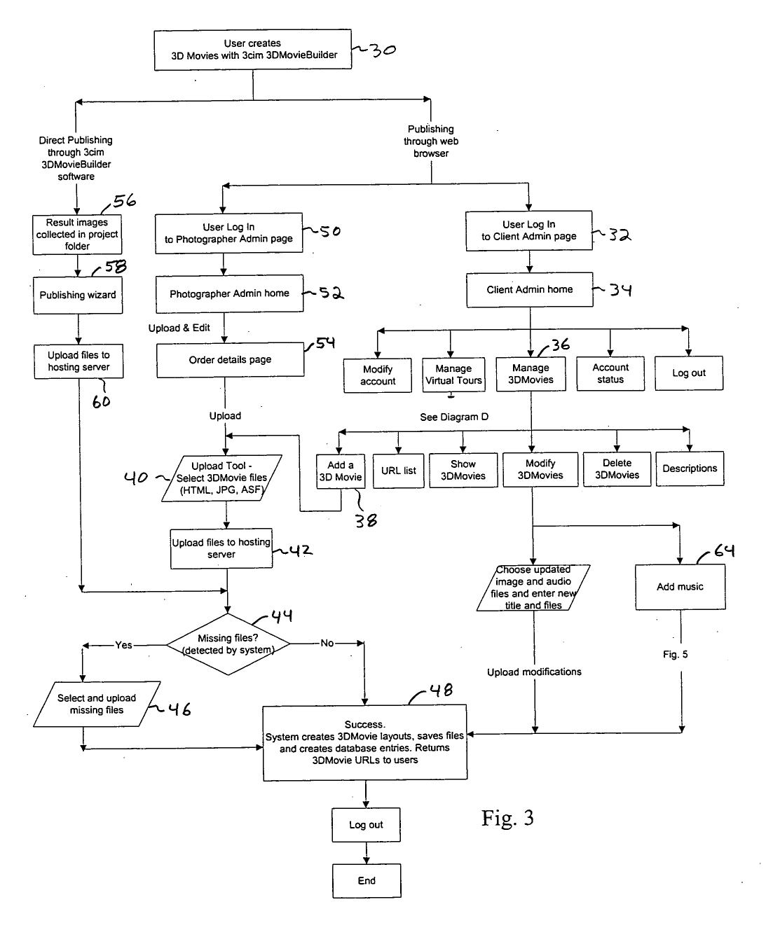

Referring to FIG. 3, a method of publishing a 3DMovie with the system 20 is shown. The method begins in step 30 with a user (i.e., designer) creating the 3DMovie with the image compiling software 16 on the local computer 12. Once the 3DMovie has been created, then the designer can either publish using a web browser or, as will be further discussed below, publish directly using the compiling software 16 as a direct publisher using the project publishing server 22.

If the designer uses the web publishing method, then the designer logs into the web-based publishing application in step 32. Specifically, the designer opens the on-line publishing tool by entering the appropriate URL using his or her web browser, as is commonly known. Referring to FIG. 10, a screen shot of a client log in page 1000 is shown. The designer (i.e., user) will enter a username and password in order to access the features of the on-line publishing tool. After logging in, the system proceeds to step 34 where an administration page 1100 as seen in FIG. 11 is presented to the user. The administration page 1100 has links allowing the user to perform administrative tasks to modify his or her account with the online publisher. The user can view a log of past orders, modify the way data is presented to the user, view a list of 3DMovies created, view URL's for published 3DMovies, view a list of descriptions of 3DMovies and manage 3DMovies. Furthermore, the user has the option to perform other operations such as modify their account 1102, manage Virtual Tours 1108, manage 3DMovies 1106, view their account status 1104, or log out of the system 1110.

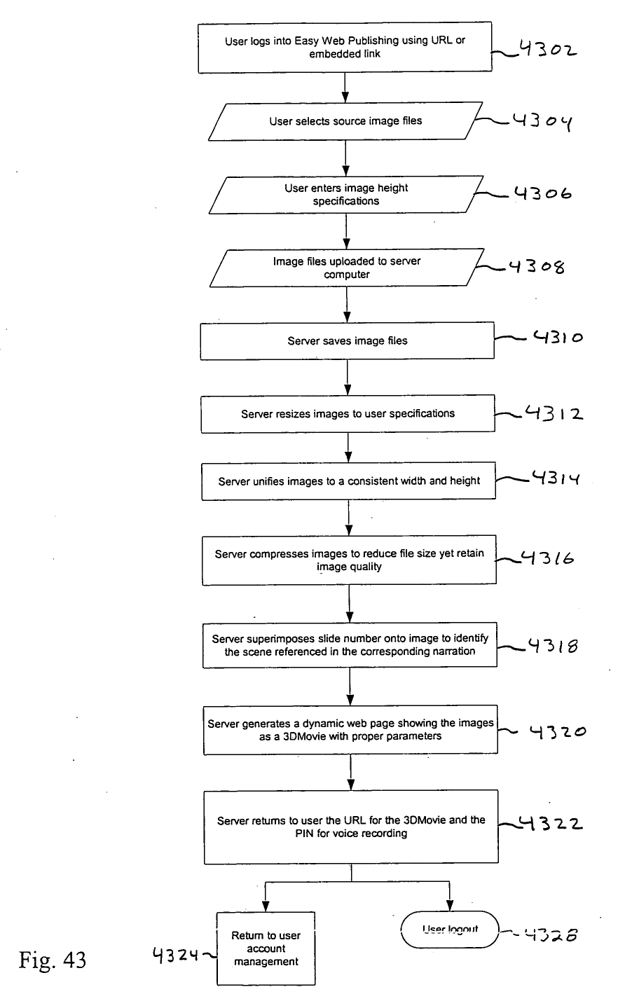

A user may create a 3DMovie via an Easy Web Publishing method shown in FIG. 43. The process begins in step 4302 by using a distinct URL to access the web-based publishing utility. Alternatively, the user can use an embedded link in the administration page 1100. From this form, the user can then select a series of image files stored on the user's machine 12 in step 4304. Once the images files have been selected, the user will then enter a desired image height in pixels in step 4306. Typically, the image height will be between 250 to 400 pixels. Next, the image files are uploaded to the server 22 in step 4308. Images uploaded through this utility are automatically saved to the server 22 in step 4310, resized in accordance with the user-specified image heights in step 4312, and unified to a consistent height and width in step 4314. Furthermore, the server 22 also compresses the image data to reduce the aggregate file size while retaining the desired image quality in step 4316. The server 22 also generates a series of sequential numbers that correspond to the number of images. These numbers are then superimposed in sequence on top of the processed images in step 4318. These numbers are used to identify and reference particular scenes within the 3DMovie in any accompanying narration. In step 4320, the server 22 then generates a dynamic web page showing the completed 3DMovie with the proper parameters of image path, image width and height, and number of images. In step 4322, the server 22 generates a dedicated URL for that presentation and a telephone number and identification (PIN) number for use in recording an audio narration that may accompany the presentation. The user may then log out in step 4328 or return to the administration page 1100 in step 4324.

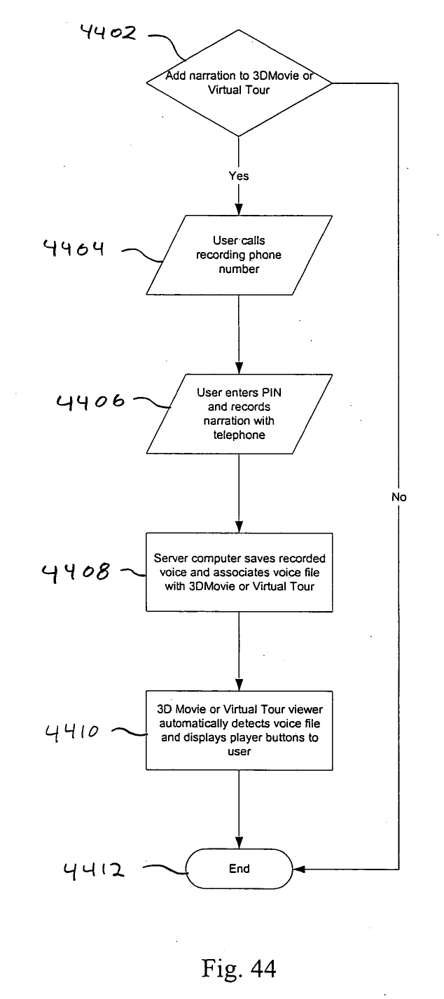

Regardless of how the user creates the presentation, the user has the opportunity to add narration to 3DMovies and Virtual Tours by using the telephone. Referring to FIG. 44, a user in step 4402 can decide to add voice to the presentation. If the user decides not to add a narration, then the process stops at step 4412. However, if the user decides to add narration, then the process proceeds to step 4404 where the user dials the phone number for recording narration. Next, in step 4406, the user enters the identification (PIN) number associated with the presentation. The user will then be prompted to begin recording the narration. The server 22 saves the audio generated during the phone call and stores the file in the same directory for the 3DMovie or Virtual Tour in step 4408. The narration may be saved with MP3 format which is then associated to the presentations that are published. In step 4410, when the presentation (i.e., 3DMovie or Virtual Tour) is played, the viewer automatically detects the voice file and displays the player buttons needed for user control.

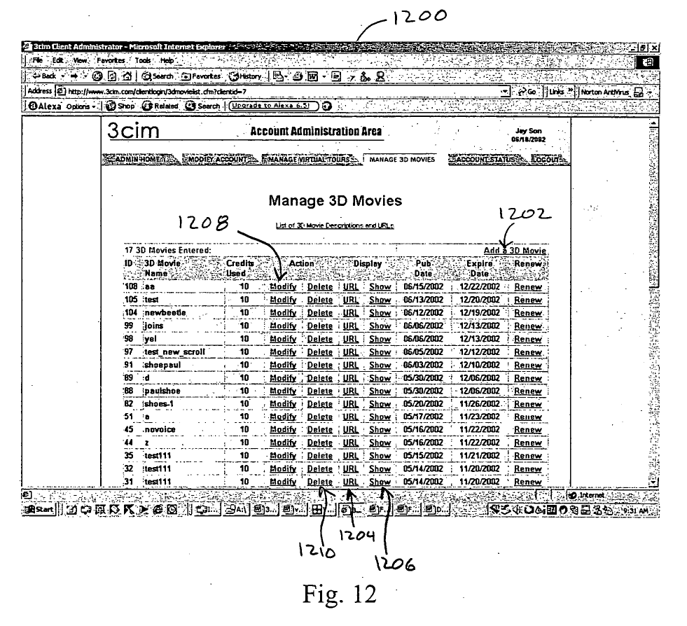

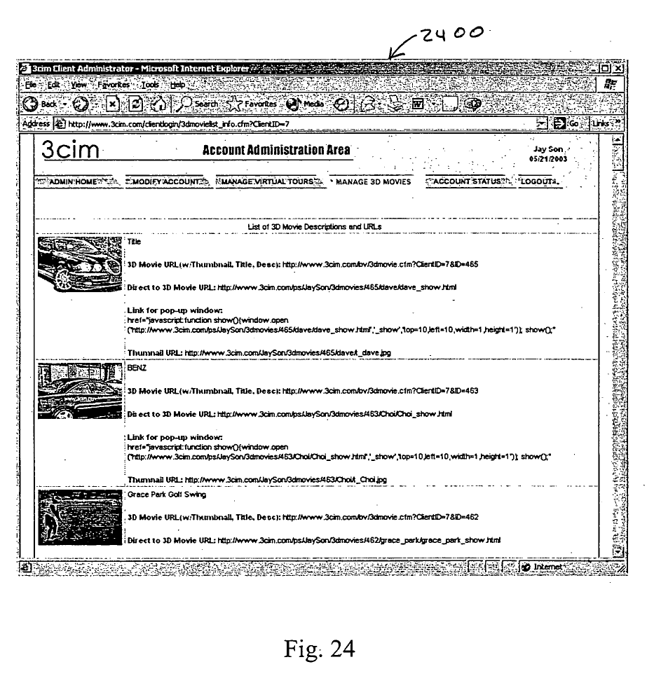

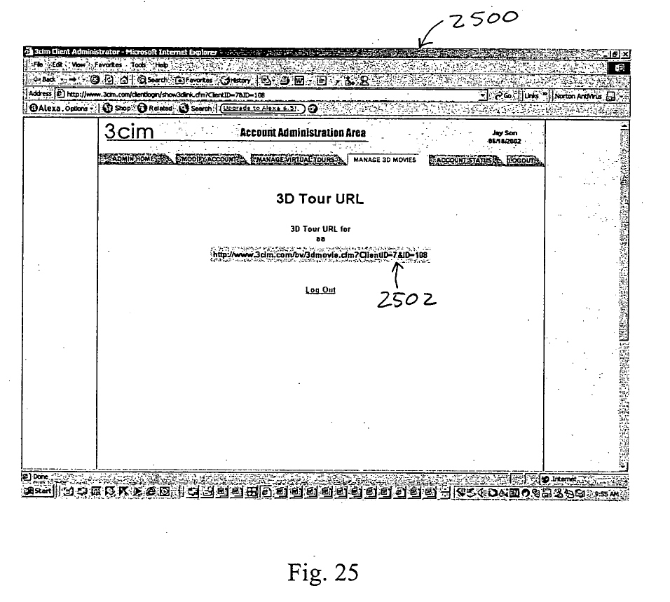

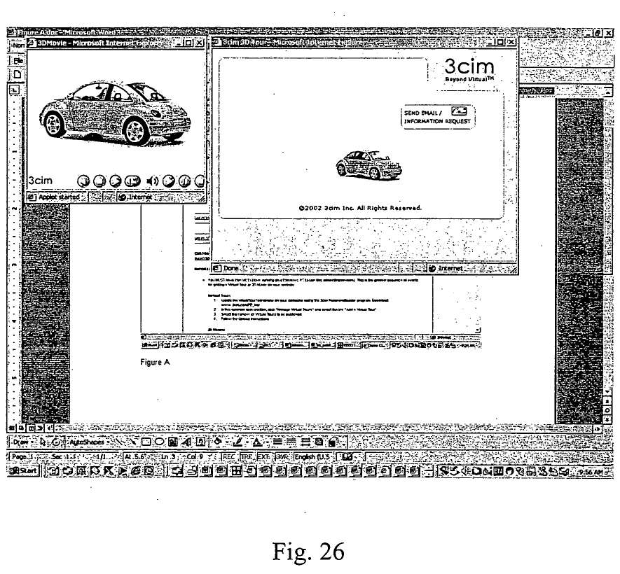

If the user selects to manage 3DMovies in step 36, then the publishing server 22 will generate a manage 3DMovie web page 1200 (FIG. 12) which shows the 3DMovies the user has created and allows the user to add new 3DMovies as needed. Specifically, the 3DMovie page 1200 allows the user to display descriptions and URL's of 3DMovies by selecting the desired URL link 1204 whereby the movie and URL description page 2400 (FIG. 24) is displayed. The 3DMovie can be viewed by selecting a show link 1206 whereby the publishing server 22 will generate a 3DMovie link page 2500 (FIG. 25). If a 3DMovie link 2502 is selected by the user, then the 3DMovie will be played in a separate window (FIG. 26). If a user wishes to delete 3DMovies from the publishing server 22, then the user selects the delete link 1210 associated with the 3DMovie to be deleted.

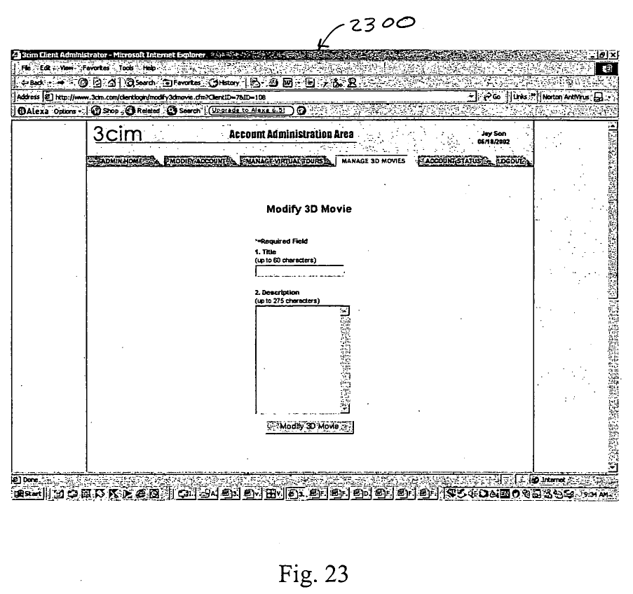

A new title and new files can be added to the 3DMovie by selecting the desired modify link 1208. When the modify link 1208 is selected, the publishing server 22 generates a modify 3DMovie page 2300 (FIG. 23) whereby the user can enter a new title, and a description to the 3DMovie, according to step 62 (FIG. 3) whereby the modifications are uploaded to the publishing server 22.

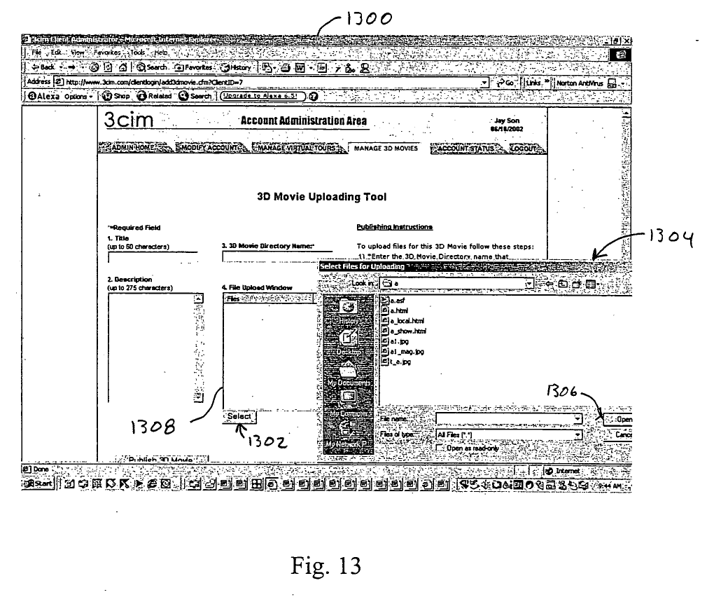

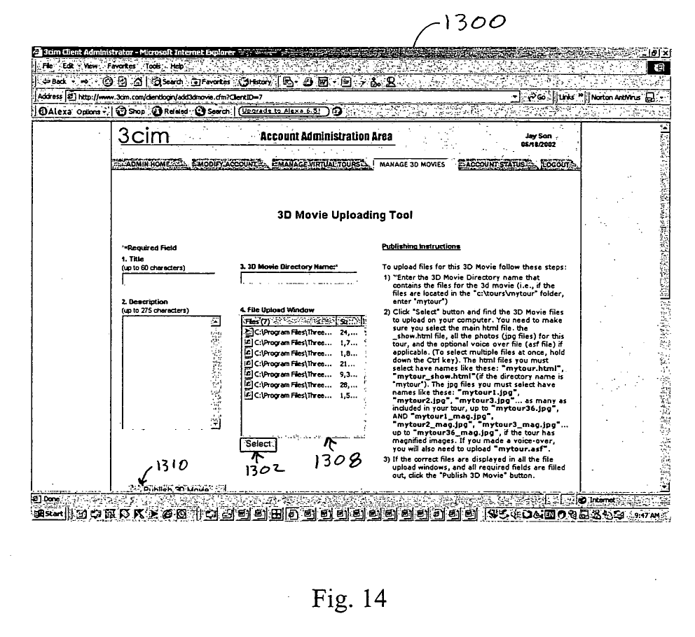

If the user decides to add a 3DMovie, the user will select the “Add 3DMovie” link 1202 on the manage 3DMovie web page 1200. Then the system 20 will proceed to step 38 and generate a 3DMovie uploading tool page 1300 shown in FIG. 13. The user will then click on the “select” button 1302 under the file upload window in order to choose the 3DMovie to upload to the publishing server 22. Once the “select” button 1302 has been clicked, then the system 20 proceeds to step 40 and a select files for uploading window 1304 will be displayed allowing the user to select the 3DMovie files to be added. Specifically, the select files for uploading window 1304 is a standard “add files” window whereby the user can select files (such as .html, .jpg, and .asf type files) from the local computer 12 for uploading to the system 20. It is also possible to use the uploading window 1304 to select files on other computers which are networked to the local computer 12. Once the files are located and highlighted, the user clicks the “open” button 1306 to add the files to the file upload window and upload the files to the publishing server 22 in step 42. In order to complete the upload of 3DMovie files, the user selects the “Publish 3DMovie” button 1310 as seen in FIG. 1400 thereby transferring all the files present in the file upload window 1308 to the publishing server 22 via ActiveX code over HTTP. In this regard, the publishing server can store the files of the 3DMovie (i.e., image files) to be accessible over the Internet.

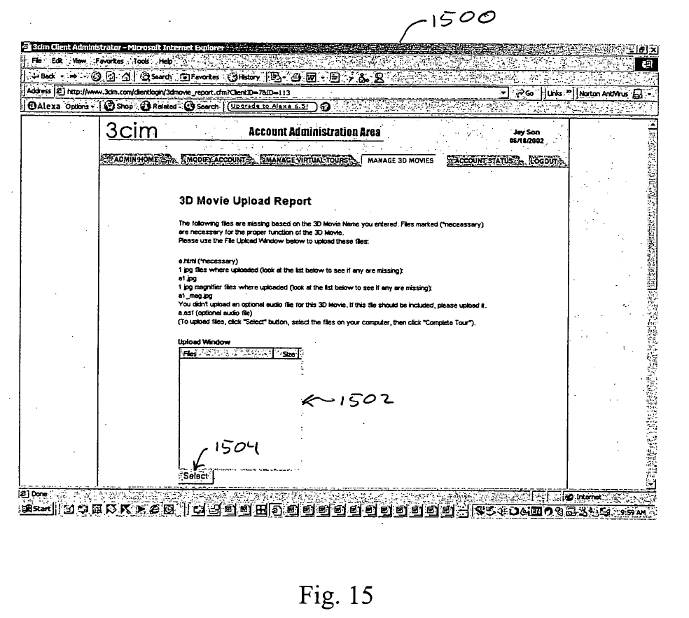

In step 44 of FIG. 3, the publishing server 22 determines whether there are any files missing from the upload. A movie upload report page 1500 (FIG. 15) will be generated with an unsuccessful upload message if any missing files are detected. The publishing server 22 detects missing files if a file name does not match to the project title or if a necessary file is not present. The user is given the opportunity to select and upload the missing files in step 46 using the upload window 1502 and select button 1504 with the procedure previously described for adding files.

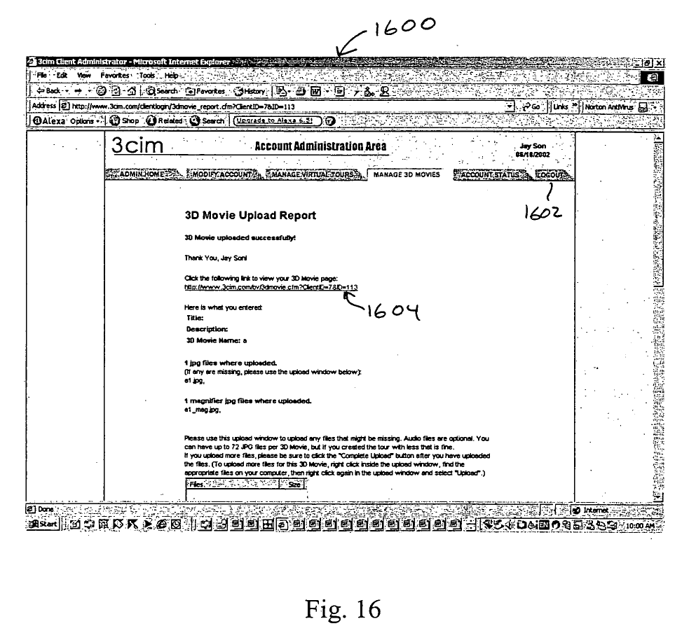

Once the required files have been uploaded, then the server 22 will generate a 3DMovie upload report page 1600 (FIG. 16) with a successful upload message in step 48. The publishing server 22 will create the 3DMovie layout, save the files and create database entries and return the URL to the user. A URL link 1604 to view the 3DMovie will be provided to the user on the report page 1600. By selecting the logout tab 1602, the session will be ended.

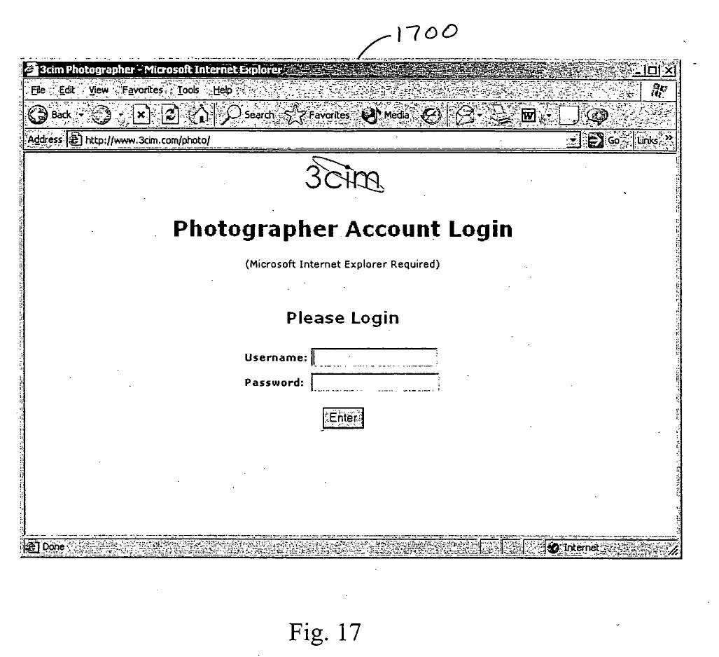

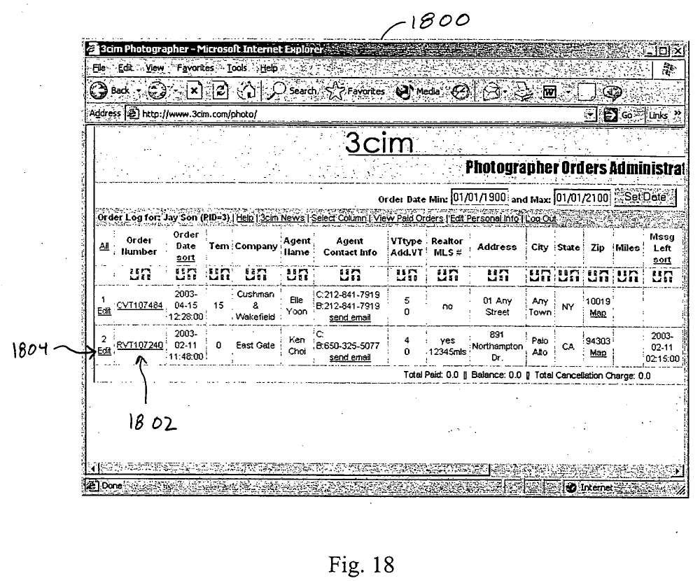

In addition to a designer uploading 3DMovies, a photographer can also upload movies that he or she has created. The photographer creates the 3DMovie in step 30 as previously described. Then the photographer accesses a photographer account login page 1700 (FIG. 17) using the web browser on his or her computer 12. After entering the username and password in step 50, the publishing server 22 generates the photographer administration page 1800 shown in FIG. 18 in operation 52. The administration page 1800 has information for all recently assigned orders. The photographer will locate the order from an order column 1802 which corresponds to the 3DMovie that he or she has created and wishes to publish. The photographer will select the edit button 1804 that corresponds to that order in order to upload the 3DMovie.

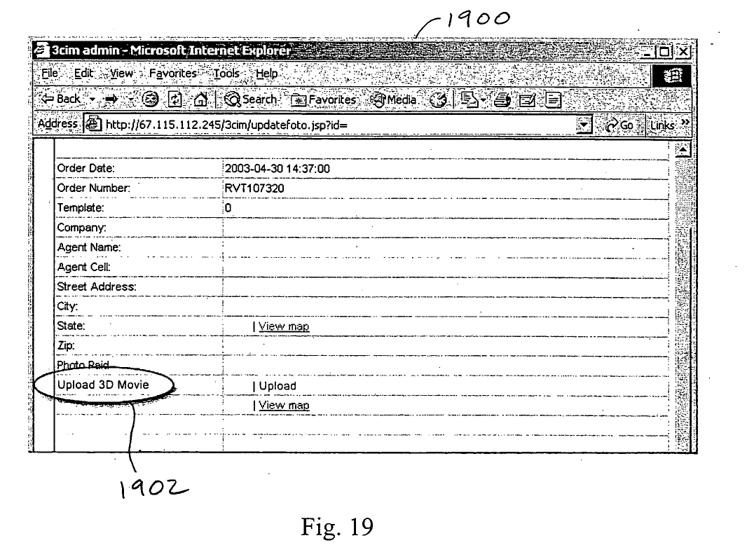

When the edit button 1804 is selected, then the publishing server 22 in step 54 generates an orders detail page 1900 (FIG. 19) with information about the pending 3DMovie order. The photographer will select “Upload 3DMovie” 1902 to begin the upload process. At this point, the process proceeds through steps 40-48 where the 3DMovie files are uploaded and the photographer can log out, as previously discussed.

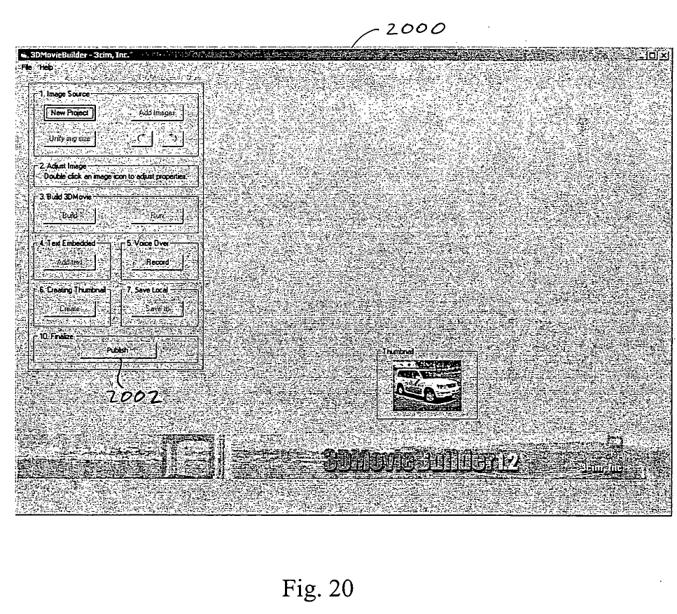

A direct method of publishing 3DMovies from the image compiling software 16 is shown in FIG. 3. With this method, the designer creates the 3DMovie with a movie creator such as 3DMovieBuilder by 3CIM, Inc. of Fremont, Calif. The 3DMovieBuilder allows the designer to create custom 3D custom movies. Referring to FIG. 20, a screen shot 2000 from the 3DMovieBuilder is shown. During creation of the 3DMovie with the MovieBuilder, images are collected into a main project folder as work progresses, as seen in step 56 of FIG. 3. Once the 3DMovie has been created and the images collected, the user selects the Publish button 2002 to begin the publication process by launching a publishing wizard in step 58. The user must log into the system 20 and provide account and order information in order to publish the series of scenes. In step 60, the publishing wizard will upload the appropriate files and account information to the publishing server 22 in order to publish the 3DMovie. Once the appropriate files have been uploaded to the publishing server 22, the process will proceed to steps 44-48 in order to determine that all of the correct files are present and to publish the 3DMovie.

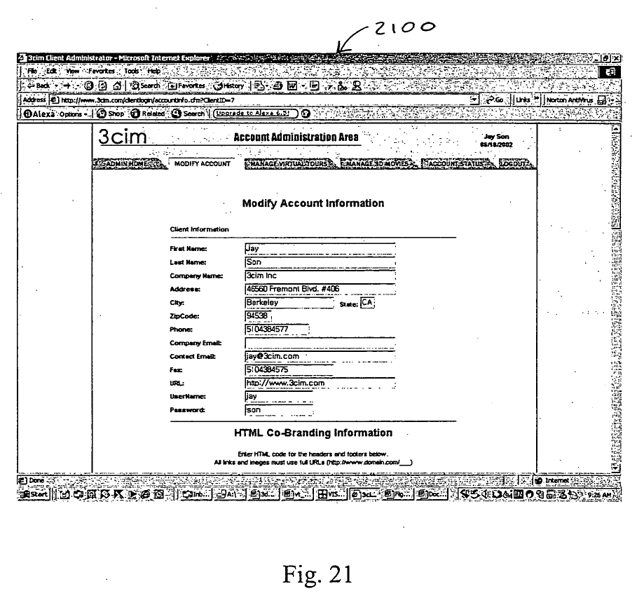

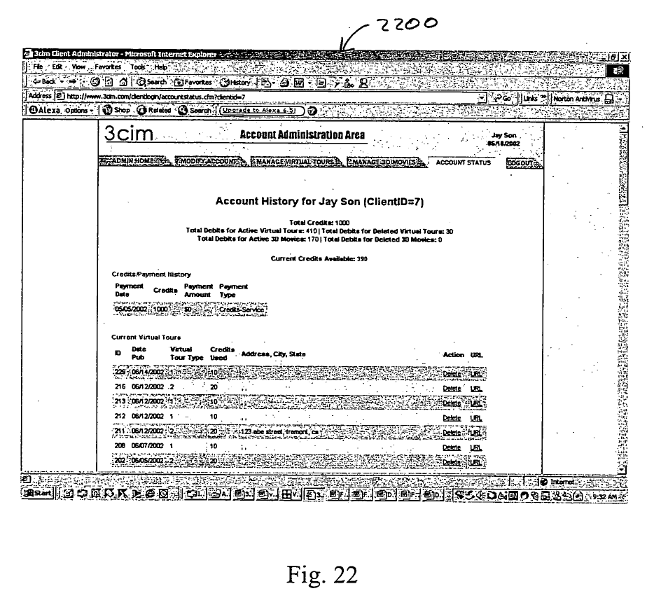

As previously mentioned above, the system 20 also provides a user the ability to modify and manage the information in his or her publishing account with the online publisher. In order to modify and/or manage an account, a user logs into the system 20 in step 32. If the user wants to modify his or her account, then the user will select the modify account tab 1102 (FIG. 11) whereby the publishing server 22 will generate the modify account information page 2100 shown in FIG. 21. The user can fill out and change contact information from the modify account information page 2100. Additionally, the user can review his or her account status by selecting the account status tab 1104 on the account administration page 1100. Referring to FIG. 22, the account history page includes information about account history, credits and debits for the account with the publishing system.

Furthermore, it is also possible with the system 20 to manage the access that users have. For example, the system 20 may be implemented for businesses involved in consumer-oriented commerce which benefit from displaying detailed images of products to the public over the Internet. Such businesses include e-commerce and web-based auction businesses. In these applications, the management of hosted data by a diverse user base becomes extremely significant. The system 20 has been designed to accommodate nearly an unlimited number of users with each having the ability to control the 3DMovies they have created.

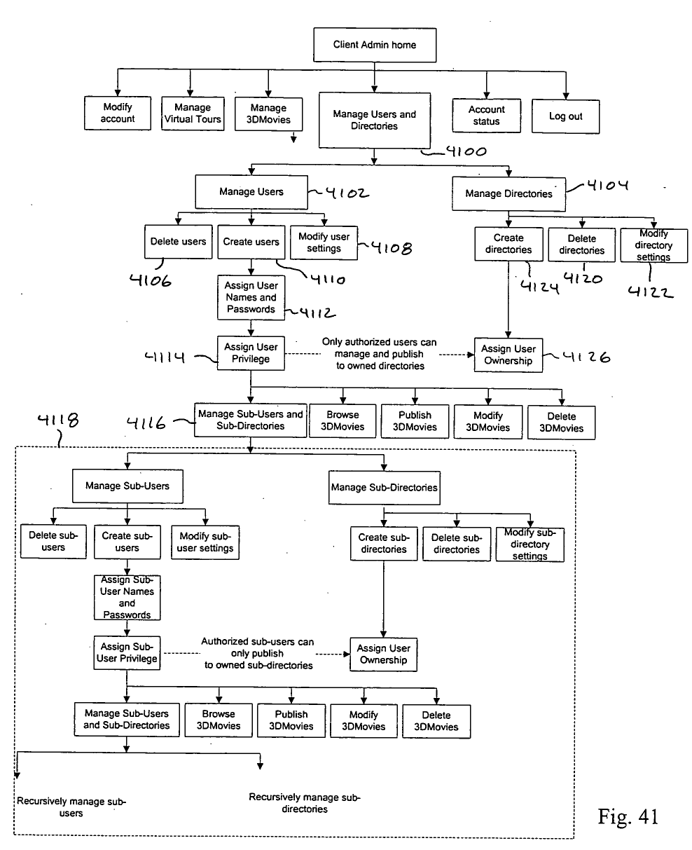

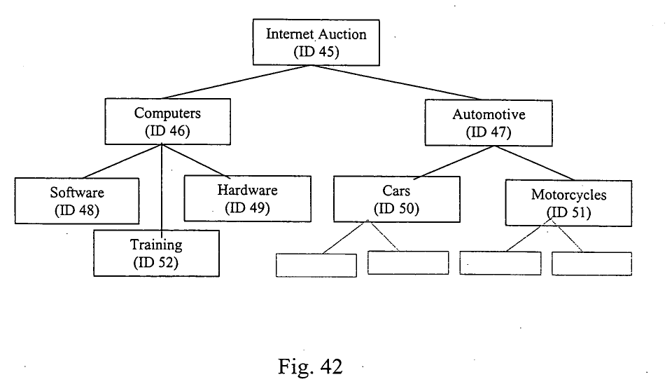

For these applications (i.e., web-based auctions and e-commerce businesses), every user will have access rights limited to his/her root entry level on their branch of a directory tree. Specifically, referring to FIG. 41, a method of granting access to different users is shown. As will be further explained below, no permissions will be granted for any other horizontal directory (on the same level), or vertically to directories up the branch. However, access will be granted for all sub-directories below the root access level. As can be evident, there are no theoretical limits to the number of subdirectories and sub-users any single user can create.

In practice, there are two models of access that are to be expected. The first model is called the “shallow model”. This structure would be utilized for users to create images used in web-based auctions. In this model, many thousands of users will be created horizontally across the same level of the tree. Each of those users will have perhaps 2 or 3 levels of subdirectories, and most will not have sub-users.

The second model is called the “deep model”. This model is typical of e-commerce sites that may have fewer directories horizontally, but many more levels of subdirectories and sub-users. For example, an on-line store would create a new branch for each product category, with sub-directories for each manufacturer, product line, product, product variant, etc., and each with an “owner” responsible for publishing to approximately 10-15 folders on each horizontal level. The advantage of this type of system is that levels may propagate themselves down through multiple branches once the model for one level is developed. Once deployed, this application will allow users to manage their own branches by adding any number of new sub-directories and new sub-users below their own access level.

Referring to FIG. 41, the management of users and directories occurs when a user having the required access select the manage and users and directories 4100. From here, the user can either manage users 4102 or manage directories 4104. If the user selects manage user 4104, then the user can delete users 4406, modify user settings 4108, or create new users 4110. User names and passwords are assigned in step 4112 and user privileges are assigned in step 4114.

If the user has the required privileges in step 4114, then the user can manage and publish to owned directories falling below. Specifically, in operation manage sub-users and sub-directories 4116, the user manages the sub-users and sub directories. As was previously discussed, the tree structure can extend downwardly as shown by box 4118 as needed.

As previously mentioned, the user can also manage directories in step 4104. From this step, the user can delete directories 4120 and modify directory settings 4122. Also, the user with the required access can create directories 4124 and assign user ownership to directories in step 4126.

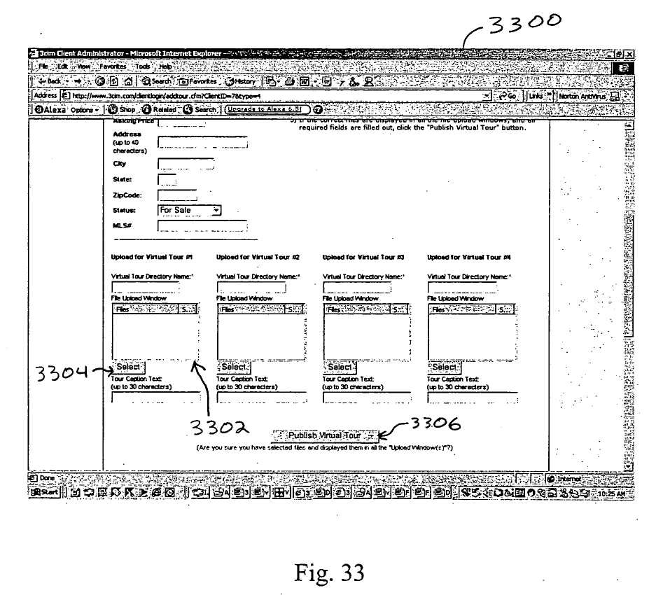

As can be seen in FIG. 33, image files may be contained in multiple directories and sub-directories. In order to render each HTML page for the 3DMovie, information about the parent directory (i.e., topmost directory) is retrieved. Next, information about the directory that the user is in is retrieved, as well as all the information about subdirectories. A list of 3DMovies published in these directories is retrieved in order to have the necessary filed to render the HTML page.

Data about the parent directly is retrieved without having to do multiple SELECT queries on the database 26. This is not significant for “shallow” tree structures, but can significantly impact the speed of navigating through a “deep” structure.

In order to eliminate unnecessary queries to the database 26, a unique coding system is used. By assigning a unique and meaningful code to each directory, it is possible to let the system know where the user is in the tree structure at any moment.

For example referring to FIG. 42 and Table 1:

TABLE 1

| ID | DIR_NAME | TITLE | LEVEL | NUM | CODE |
|---|---|---|---|---|---|
| 45 | auction | Internet Auction | 1 | 1 | |
| 46 | computers | Computers | 2 | 1 | 45 |
| 47 | auto | Automotive | 2 | 2 | 45 |
| 48 | software | Software | 3 | 1 | 45-46 |
| 49 | hardware | Hardware | 3 | 2 | 45-46 |
| 50 | cars | Cars | 3 | 1 | 45-47 |
| 51 | motorcycles | Motorcycles | 3 | 2 | 45-47 |
| 52 | training | Training | 3 | 3 | 45-46 |

In Table 1, ID, LEVEL, and NUM are integers, while DIR_NAME, TITLE and CODE are text fields (varchar). For example, referring to Table 1 and FIG. 42, “Hardware” (code 45-46) has 2 parents (LEVEL=3) and is the second item in the list of subdirectories (NUM=2). The parent at level 1 has ID 45 while the parent at level 2 has ID 46. By processing a directory code, all of the parent IDs for Hardware are known and their information is retrieved in one SELECT statement:

SELECT* from DIRECTORIES where ID=‘45’ or ID=‘46’, order by LEVEL

The list of subdirectories for Hardware can be retrieved by using this statement:

SELECT* from DIRECTORIES where CODE=‘45-46-49’, order by NUM

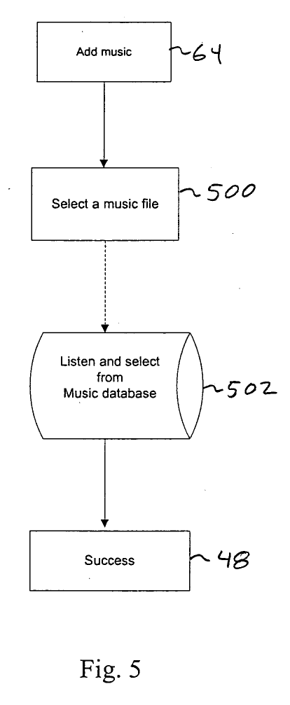

In addition to the foregoing, it is also possible to modify the 3DMovies to include music and/or voice. As seen in FIG. 3, in step 64, the user can add music to the 3DMovies he or she has created or published. Referring to FIG. 5, when the user has the option to add music in step 64, the user selects music files in step 500 from his or her computer 12. Alternatively, in step 502, the user can listen and select music files from the database 26 of the publishing system 20. Once the user selects the desired music files, then the process returns to step 48 of FIG. 3 wherein the files are saved and published with the 3DMovie. In addition to selecting music files, it may also be possible to add voice files to the 3DMovie. The voice files can be recorded when creating the 3DMovie and can be published with the images and HTML files. Music can be added when publishing the 3DMovie or when modifying the 3DMovie (as shown in FIG. 3). If voice files exist, then the music file will be mixed therewith when the 3DMovie is displayed.

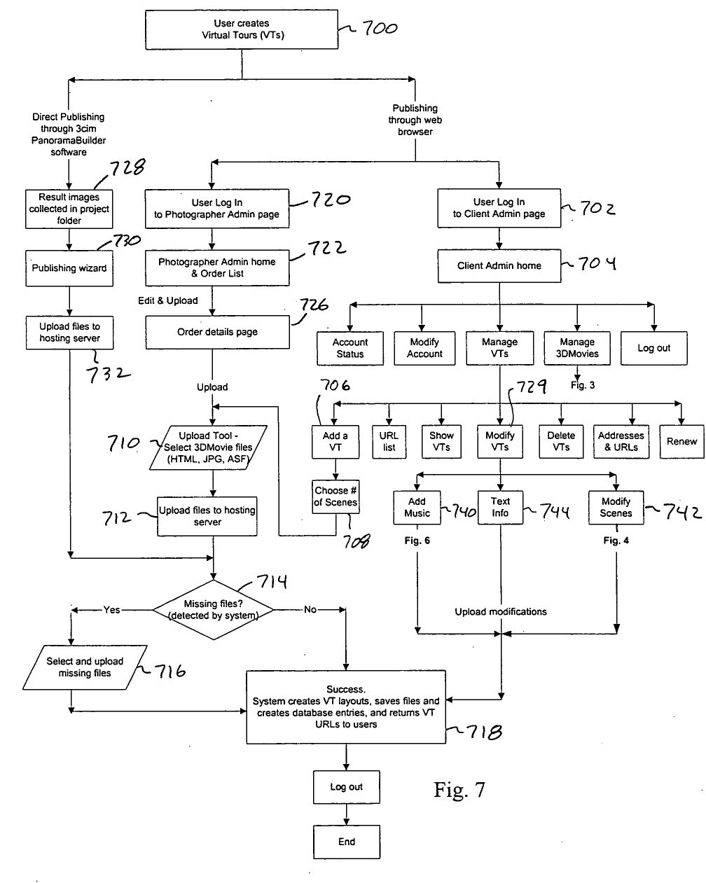

The publishing system 20 can also be used to publish Virtual Tours (VTs). As previously mentioned above, the Virtual Tour is a series of images stitched together to form a seamless image that can be rotated while being displayed. A Virtual Tour template is a series of individual Virtual Tours (i.e., scenes) of the same object or property. For example, a Virtual Tour template of a house might include individual Virtual Tour scenes of different rooms. The process of creating the Virtual Tour is similar to the process of creating the 3DMovie. Specifically, as seen in step 700 of FIG. 7, the process begins with a user (i.e., designer) creating the Virtual Tour with the image stitching software 14 on the local computer 12 (FIG. 2). Once the Virtual Tour has been created, then the designer can either publish using a web browser or publish directly using the Virtual Tour building software 14 as a direct publisher using the project publishing server 22.

If the designer uses the web publishing method, then the designer logs into the web-based publishing application in step 702. This is the same process for the publication of 3DMovies. Specifically, the designer opens the on-line publishing tool by entering the appropriate URL using his or her web browser and enters his or her username and password when the log in page 1000 (FIG. 10) appears. Once the user has logged in, the account administration page 1100 (FIG. 11) is generated in step 704. The user can then add new Virtual Tours by selecting the manage Virtual Tours tab 1108.

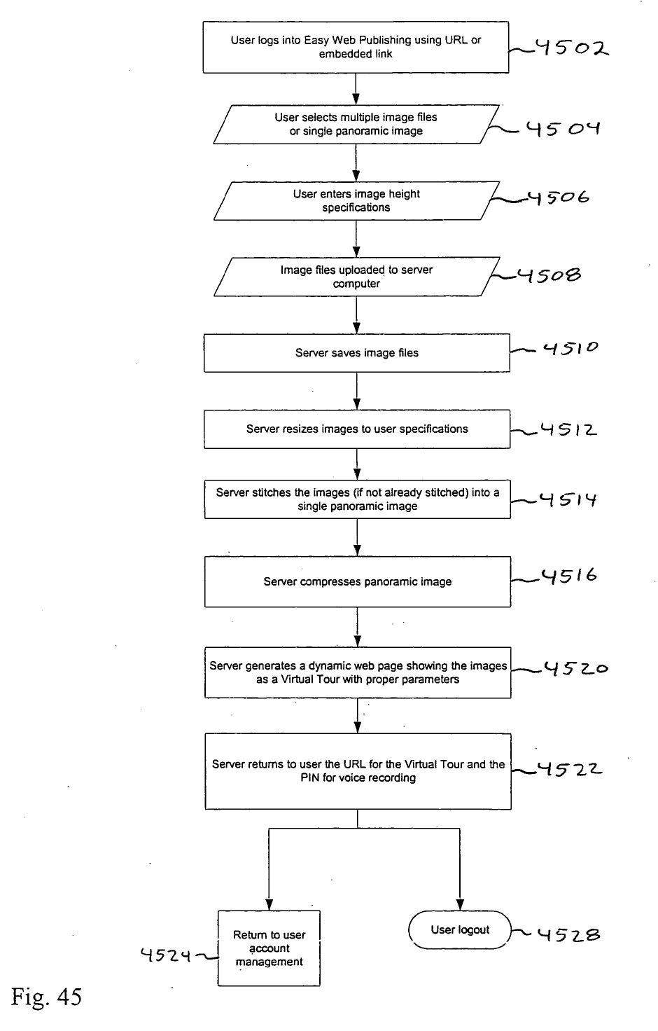

A user may create a Virtual Tour via an Easy Web Publishing method shown in FIG. 45. The process begins in step 4502 by using a distinct URL to access the web-based publishing utility. Alternatively, the user can use an embedded link in the administration page 1100. From this form, the user can then select a series of image files or a single panoramic images stored on the user's machine 12 in step 4504. Once the images files have been selected, the user will then enter a desired image height in pixels in step 4506. Typically, the image height will be between 250 to 400 pixels. Next, the image files are uploaded to the server 22 in step 4508. Images uploaded through this utility are automatically saved to the server 22 in step 4510 and resized in accordance with the user-specified image heights in step 4512. Next the server 22 stitches the images into a single panoramic image in step 4514 if the images are not already stitched together. In step 4516, the server 22 also compresses the image data to reduce the aggregate file size while retaining the desired image quality. The server 22 generates a dynamic web page that shows the completed Virtual Tour in step 4520. The Virtual Tour is shown with the proper parameters of image path and image width and height. In step 4522, the server 22 generates a dedicated URL to the Virtual Tour and a telephone number and identification number (PIN) for use in recording an audio narration that may accompany the presentation. The user may then log out in step 4528 or return to the administration page 1100 in step 4524. The user can then add a narration to the Virtual Tour using the procedure discussed for FIG. 44.

Regardless of how the user publishes the images, the user has the opportunity to add narration to 3DMovie presentations and panoramas by using the telephone. Referring to FIG. 44, a user in step 4402 can decide to add voice to the presentation. If the user decides not to add a narration, then the process stops at step 4412. However, if the user decides to add narration, then the process proceeds to step 4404 where the user dials the phone number given to him or her for adding a narration. Next, in step 4406, the user enters the identification (PIN) number associated with the presentation. The user will then be prompted to begin recording the narration. It will be recognized by those or ordinary skill in the art, that after recording the narration, the user can have the opportunity to edit the message as necessary. The server 22 saves the audio generated during the phone call and stores the file in the same directory for the presentation in step 4408. The narration may be saved with MP3 format and then connected to the presentations that are published. In step 4410, when the presentation (i.e., 3DMovie or Panorama) is played, the viewer automatically detects the voice file and displays the player buttons for the user control.

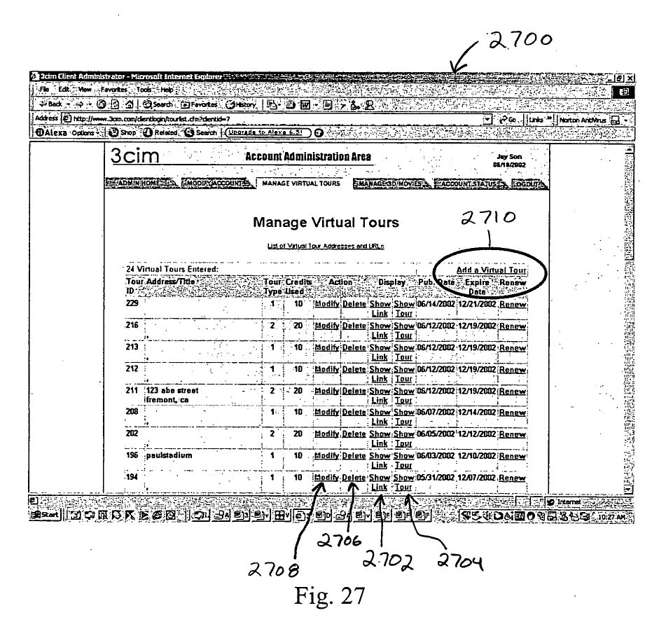

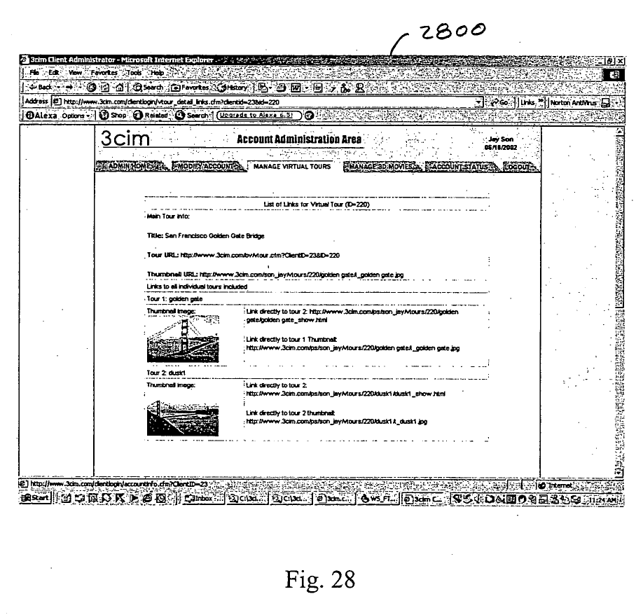

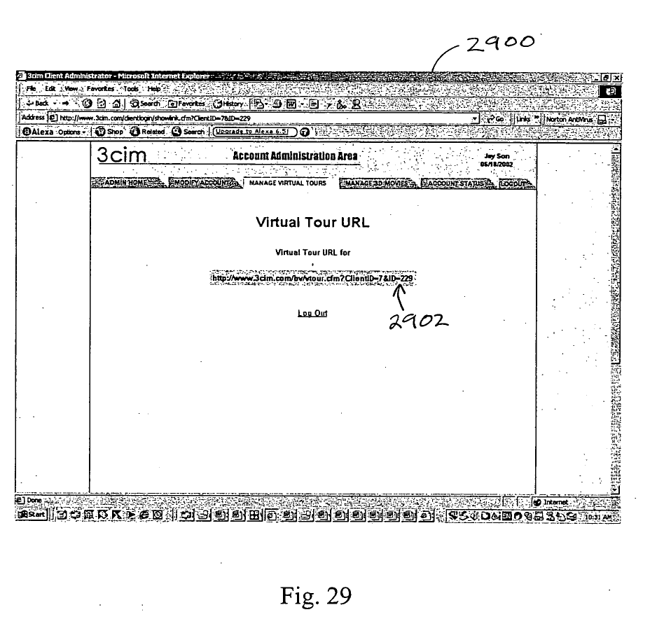

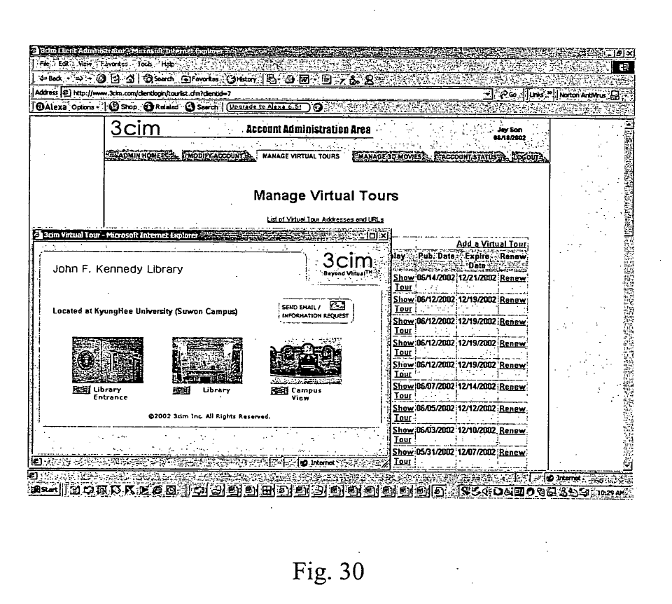

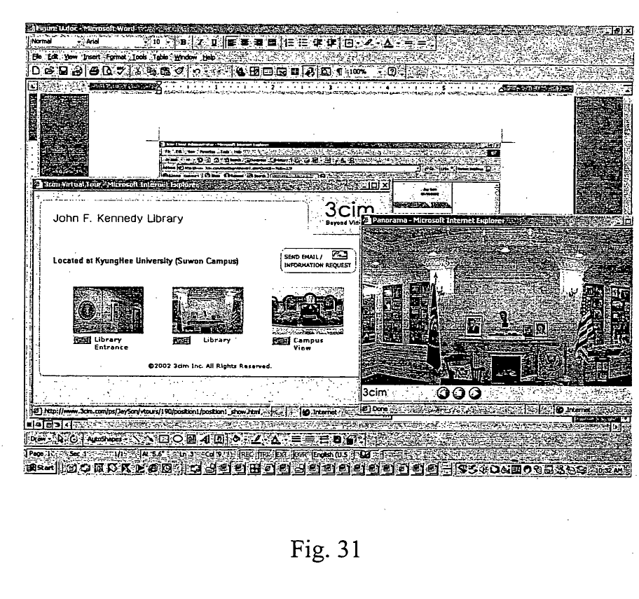

If the user selects manage Virtual Tours tab 1108, then the publishing server 22 will generate a manage Virtual Tours page 2700 (FIG. 27) that lists the Virtual Tours that the user has created and allows the user to add new Virtual Tours as desired. The manage Virtual Tours page 2700 allows the user to display descriptions and URL's of Virtual Tours by selecting the desired URL link 2702 whereby a Virtual Tour and URL description page 2800 (FIG. 28) is displayed. The Virtual Tour can be viewed by selecting a show tour link 2704 (FIG. 27) whereby the publishing server 22 will generate a Virtual Tour link page 2900 (FIG. 29) having a Virtual Tour view link 2902. If the Virtual Tour view link 2902 is selected by the user, then the Virtual Tour will be displayed in a separate window (FIGS. 30 & 31). If the user wishes to delete a desired Virtual Tour from the publishing server 22, then the user selects the delete link 2706 (FIG. 27) associated with the Virtual Tour to be deleted.

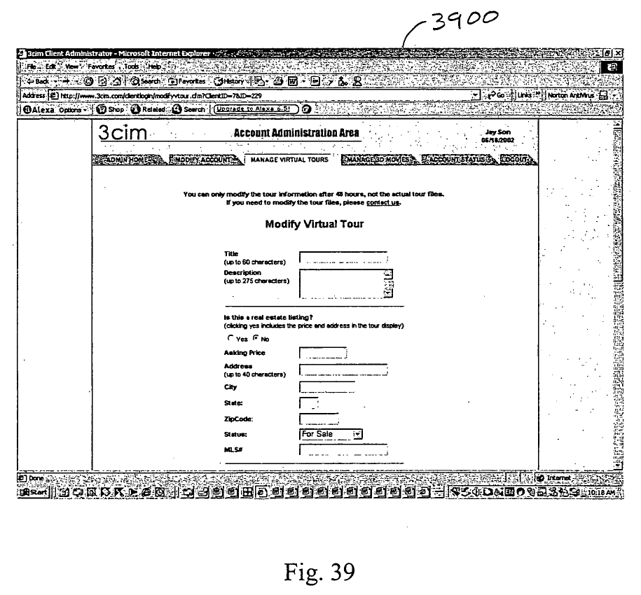

If the user wishes to modify the Virtual Tour, then the user selects the appropriate modify link 2708 from the manage Virtual Tours page 2700. When the modify link 2708 is selected, the publishing server 22 generates a modify Virtual Tours page 3900 (FIG. 39) whereby the user can enter a new title, description, pricing information, etc. . . . .

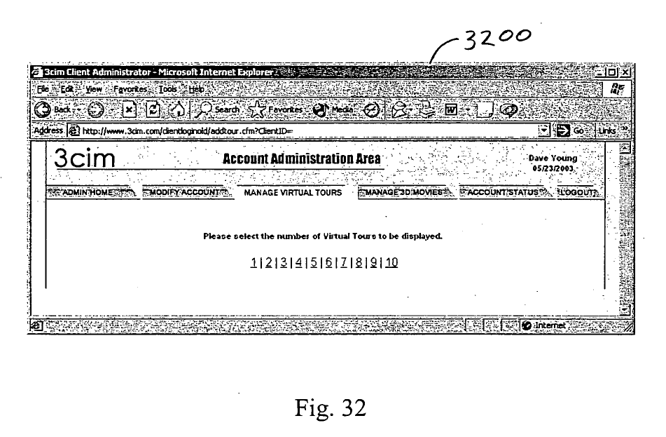

If the user decides to add a scene to a Virtual Tour template, then the user will select the “Modify” link 2708 on the manage Virtual Tours page 2700. Then, the system 20 will proceed to step 708 whereby the user will have the opportunity to select the number of scenes to be added. Referring to FIG. 32, the user can select between one and ten scenes for the Virtual Tour from a scene selection page 3200. The scenes refer to how many different Virtual Tour images the user wishes to be displayed when the viewer selects the product or property. For example, as mentioned above, a Virtual Tour template may consist of multiple scenes showing different views of the product or property. The user has the opportunity to publish between one and ten scenes.

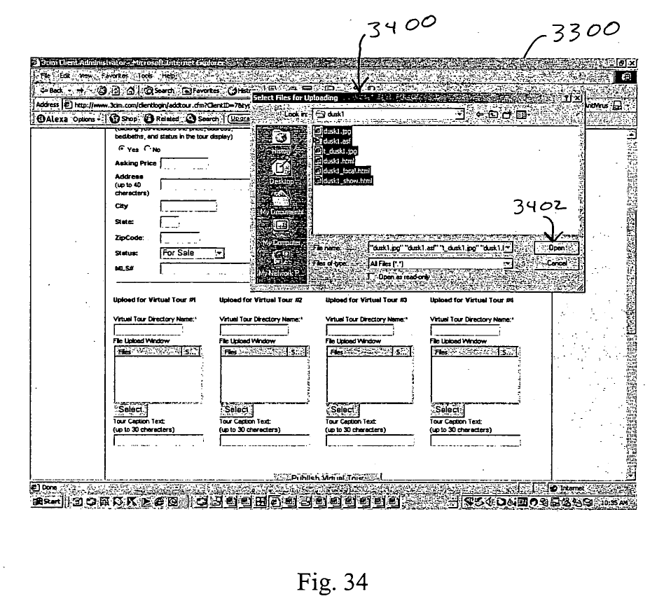

Once the user has selected the number of scenes to be published, then the process continues to step 710 whereby the user can upload the appropriate files. Specifically, upload page 3300 will be displayed with upload windows 3302 for the number of scenes selected. The user will then click on the “select” button 3304 under one of the corresponding file upload windows 3302 in order to upload the Virtual Tour to the publishing server 22. Once the “select” button 3304 has been clicked, then a file selection uploading window 3400 (FIG. 34) will be displayed that permits the user to select the Virtual Tour files to be added. Specifically, the file selection uploading window 3400 is a standard “add files” window whereby the user can select files (such as .html, .jpg, and .asf type files) from the local computer 12 for uploading to the system 20. It is also possible to use the uploading window 3400 to select files on other computers which are networked to the local computer 12. Once the files are located and highlighted, the user clicks the “open” button 3402 to add the files to the file upload window 3302. The user repeats this process for each of the scenes the user wishes to be published with each respective file upload window 3302. In order to complete the upload of Virtual Tour files, the user selects the “Publish Virtual Tour” button 3306 (FIG. 33). Accordingly, referring to FIG. 7, the process will proceed to step 712 whereby all the files present in the file upload windows 3302 will be uploaded to the publishing server 22 via ActiveX code over HTTP. In this regard, the publishing server 22 can store the files of the Virtual Tour (i.e., image and document files) in order to be accessible over the Internet.

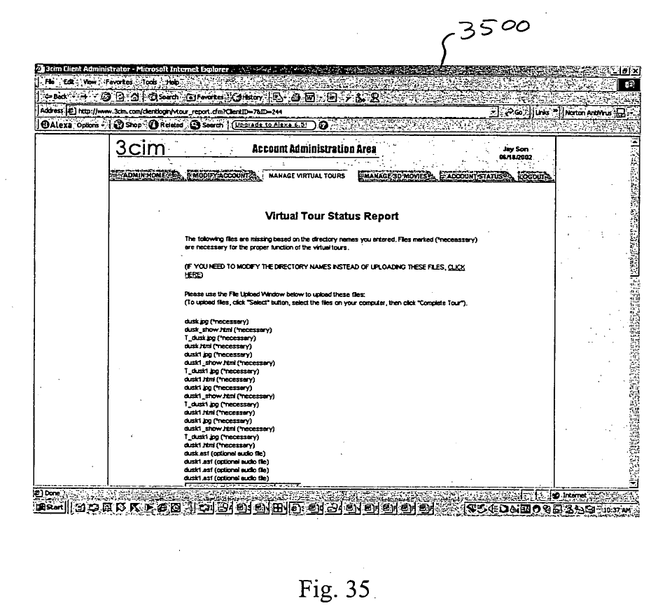

In step 714 of FIG. 7, the publishing server 22 determines whether there are any files missing from the upload. A Virtual Tour status report 3500 (FIG. 35) will be generated with an unsuccessful upload message and a list of missing files if the upload was not successful or any missing files are detected. The publishing server 22 detects missing files if a file name does not match to the project title or if a necessary file is not present. The user is given the opportunity to select and upload the missing files in step 716 using the upload window 3302 and select button 3304 with the procedure previously described.

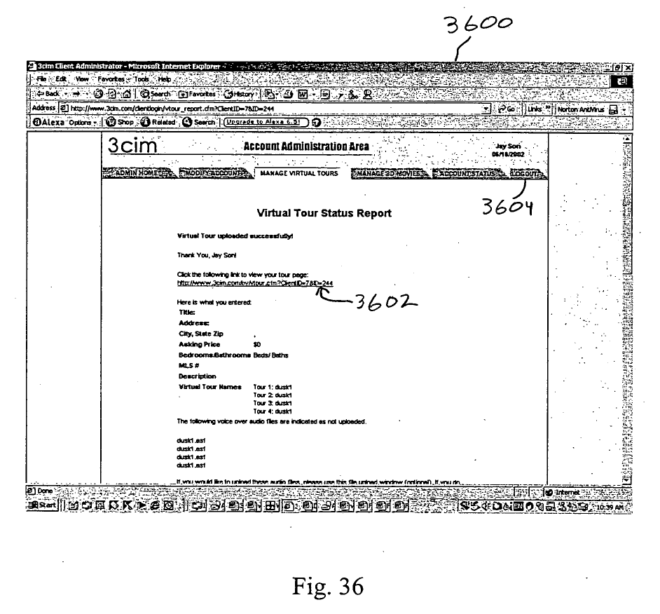

Once the required files have been uploaded, then the server 22 will generate a Virtual Tour status report 3600 with a successful upload message (FIG. 36). The status report 3600 will contain a Virtual Tour viewing link 3602 that the user can select to view the published Virtual Tour, as well as include other information such as the name of the tours that the user published. Referring to FIG. 7, in step 718, the publishing server 22 will create the Virtual Tour layout, save the files and create database entries and return the URL to the user. By selecting the logout tab 3604, the user can end the session.

In addition to a user uploading Virtual Tours, a photographer can also upload Virtual Tours that he or she has created. Referring to FIG. 7, the photographer creates the Virtual Tour in step 700, as previously described. Then the photographer accesses a photographer account login page 1700 (FIG. 17) by entering his username and password as shown in step 720. Next, in step 722, the publishing server 22 generates a photographer administration page 1800 that has information for all recently assigned orders (FIG. 18). The photographer will locate the order that he or she has created the Virtual Tour from the order column 1802. The photographer will select the edit button 1804 that corresponds to that order to upload the Virtual Tour.

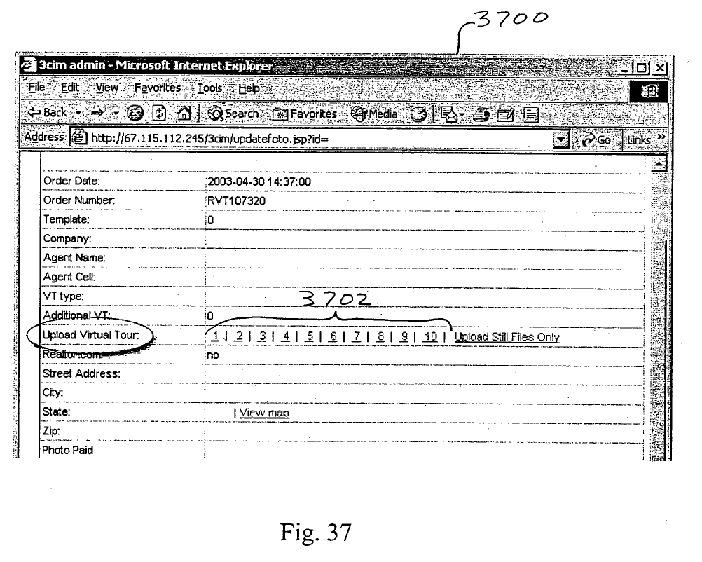

When the edit button 1804 is selected then the publishing server 22 in step 726 generates an orders detail page 3700 (FIG. 37) with information about the pending Virtual Tour order. The photographer will select the number of scenes to upload from the list of scene numbers. At this point, the process proceeds through steps 710-718 where the 3DMovie files are uploaded, and the photographer can log out as previously discussed.

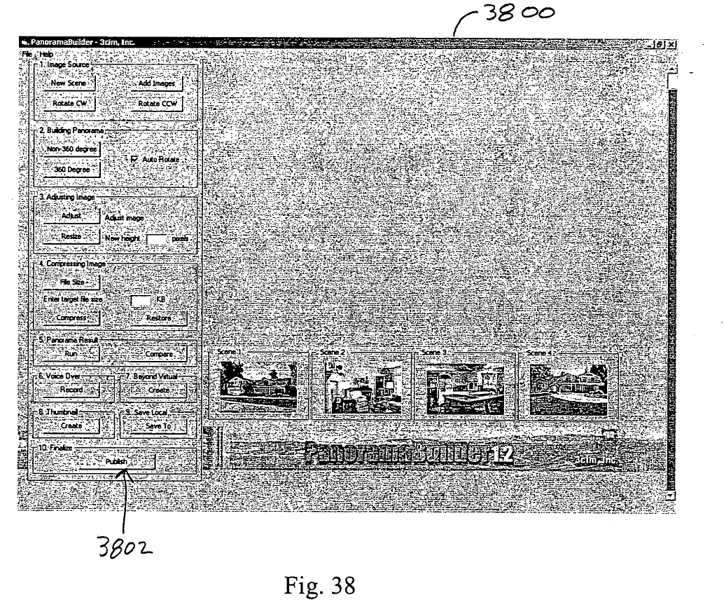

A direct method of publishing Virtual Tours from the image stitching software 16 is shown in FIG. 7. With this method, the designer creates the Virtual Tour with software such as PanoramaBuilder by 3CIM, Inc. of Fremont, Calif. PanoramaBuilder allows the designer to create custom Virtual Tours. Referring to FIG. 38, a screen shot 3800 from PanoramaBuilder is shown. During creation of the Virtual Tour with PanoramaBuilder, images are collected into a main project folder as work progresses, as seen in step 728 of FIG. 7. Once the Virtual Tour has been created and the images collected, the user selects the Publish button 3802 to begin the publication process by launching a publishing wizard in step 730. The user must log into the system 20 and provide account and order information in order to publish the series of scenes. In step 732, the publishing wizard will upload the appropriate files and account information to the publishing server 22 in order to publish the Virtual Tour. Once the appropriate files have been uploaded to the publishing server 22, the process will proceed to steps 712-718 in order to determine that all of the correct files are present and to publish the Virtual Tour, as previously discussed.

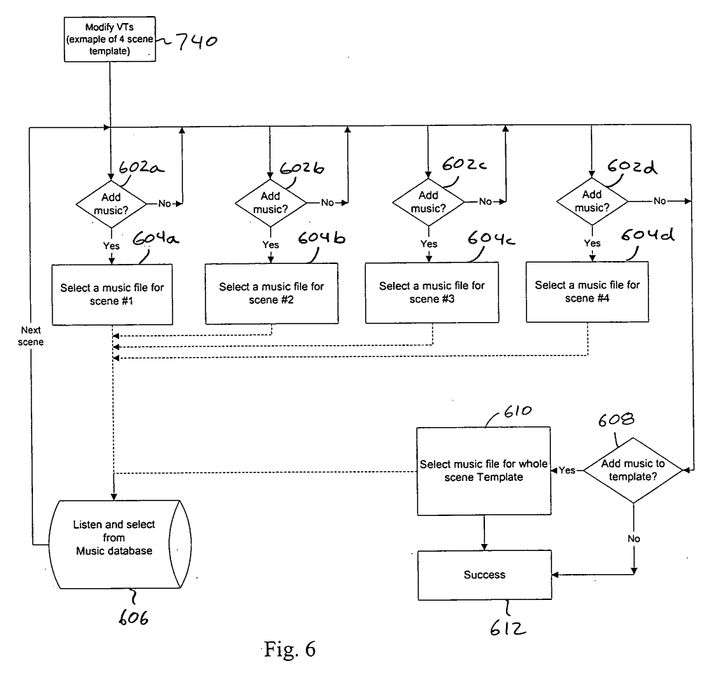

In addition to the foregoing, it is also possible to modify existing Virtual Tours, add text, music and/or voice. As seen in FIG. 7, in step 729, the user can modify Virtual Tours he or she has created. In step 740, the user can add music to the Virtual Tour. Specifically, referring to FIG. 6, the user has the option of adding music to just one scene or to the whole scene template. In steps 602a-602d, the user has the option to add music to each individual scene. If the user decides to add music, then in steps 604a- 604d, the user selects the music file for each respective scene from the database of music 606. For example, for scene #1, the user will select the music in step 604a by listening and selecting the desired music from the music database 606. If the user decides not to add any music to the scenes in steps 602a- 602d, then the user still has the option to add music to the Virtual Tour template in step 608. Specifically, in step 608, the user can select music that will be played with each of the scenes. In step 610, the user selects the music file from the database 606. Once music has been selected, the procedure returns to step 718 of FIG. 7 whereby the Virtual Tour is published with the music.

It will be recognized that voice files can be recorded when each scene is created. In this instance, the voice files will be published with the HTML files of the image in step 718. Music files can be added when modifying the scenes or when the scene is created. If both voice and music files exist, then the music file will be mixed with the voice file such that both files will be played.

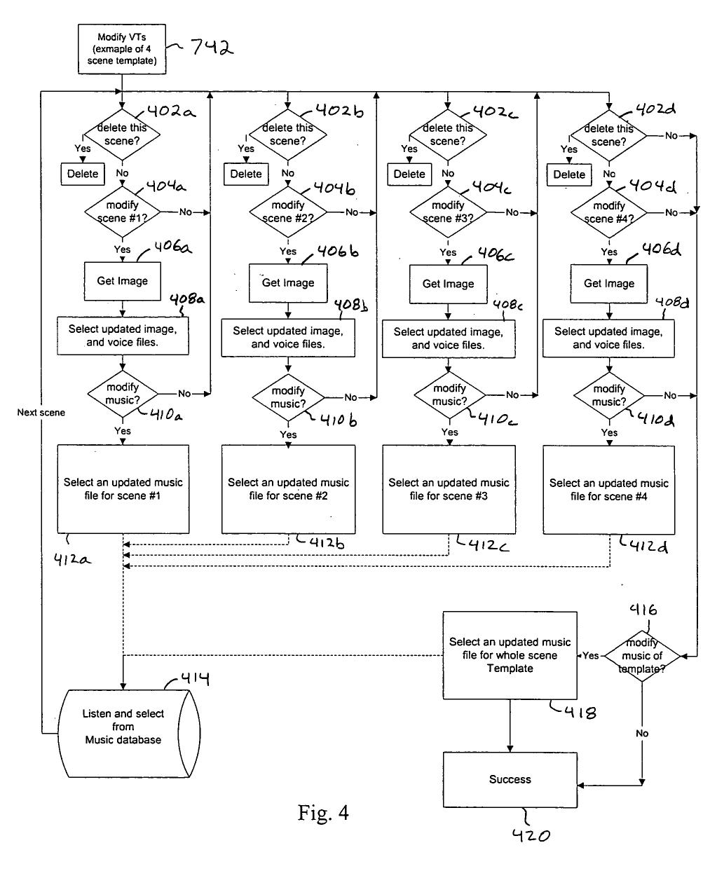

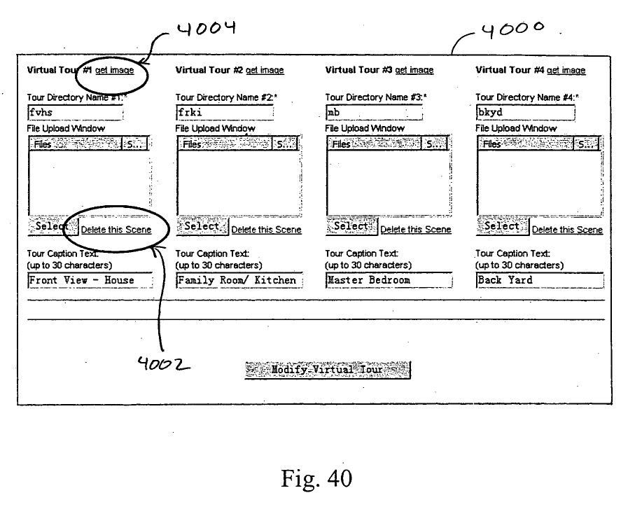

The publishing system 20 also allows a user to modify individual scenes that make up a Virtual Tour. Specifically, from step 729 of FIG. 7, the user can modify scenes in step 742. This will allow the user to individually select scenes from a Virtual Tour template, and delete or modify the scene. Referring to FIG. 4, the process for modifying a single scene (scene 1) will be described. However, as seen in FIG. 4, the process is also applicable to scenes 2-4. In step 402a, the user can delete the scene altogether. Referring to FIG. 40, a screen shot 4000 showing how a user can modify a scene is shown. By selecting the link “Delete this Scene” 4002, the scene can be deleted. As seen in screen shot 4000, each of the four scenes can be deleted. If the user decides not to delete the scenes, the user can decide to modify the scenes in step 404a. In step 406a, the user retrieves the image to be modified by selecting the “get image” link 4004. The user selects updated image and voice files in step 408a. In step 408a, the user can modify the music and select updated music from database 414 in step 412a. Once the user has completed modifying the scene, the user can decide to modify the music of the template (i.e., all of the scenes) in step 416. In step 418, the user selects an updated music file for the whole scene template from the database 414. Once the modifications have been completed in step 420, the process returns to step 718 of FIG. 7 whereby the new scenes are published with the modifications. Additionally, it is possible to modify the text information such as the tour title and property details to the scene in step 744.

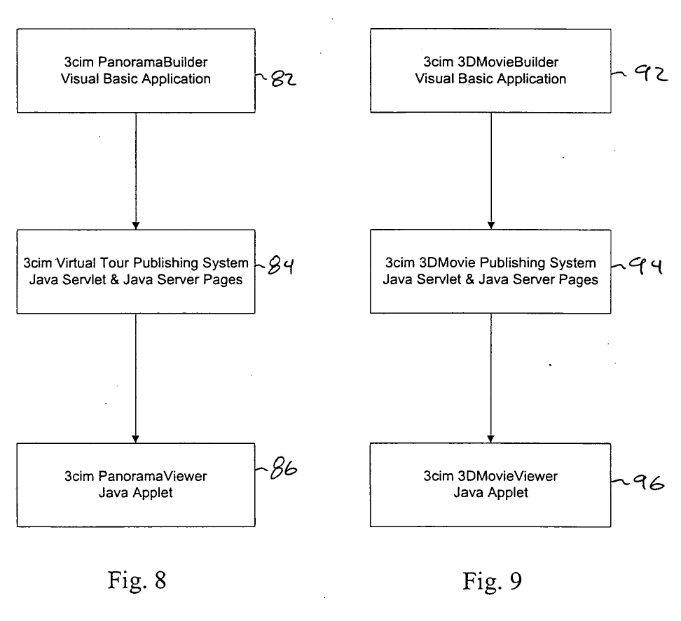

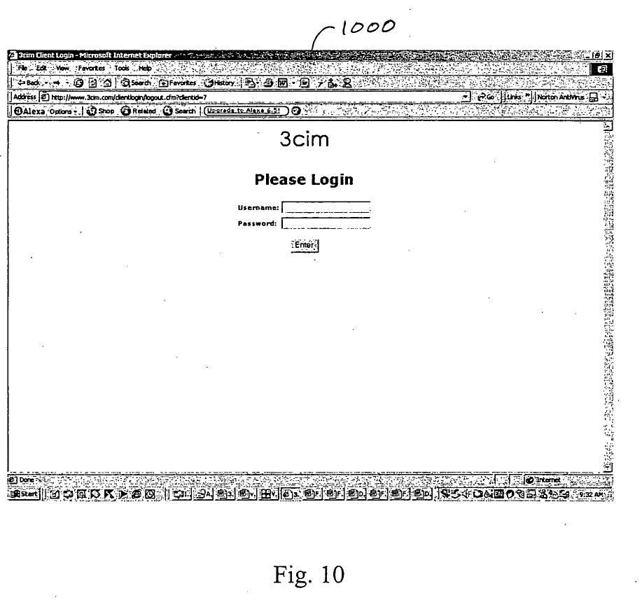

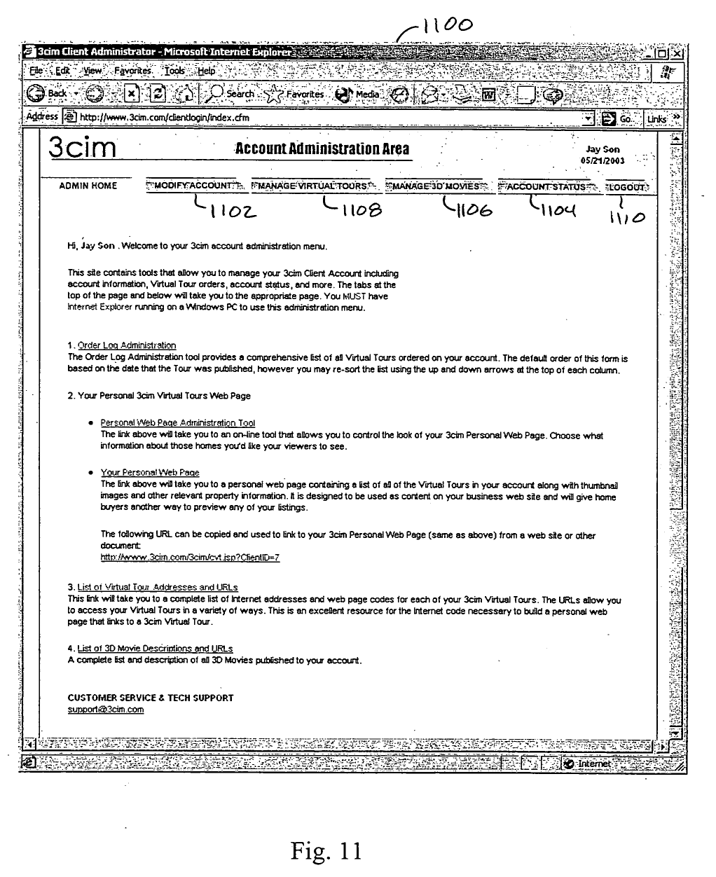

Referring to FIG. 8, a block diagram showing the applications used to create and publish a Virtual Tour are shown. Specifically, the PanoramaBuilder is a Visual Basic application 82, whereas the publishing system is a Java Servlet and Java Server Page 84. The application used to view Virtual Tours is a Java Applet 86 that operates on a viewers machine. Similarly, FIG. 9 illustrates the applications to create and publish a 3DMovie. The 3DMovieBuilder is a Visual Basic application 92, the publishing system is a Java Servlet and Java Server Page 94 and the application used to view 3DMovies is a Java Applet 86.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

What is claimed is:

1. A method for a user to create a presentation that is published on the Internet, the method comprising the following steps:
selecting image files from a computer of the user;
uploading the image files to a server computer from the computer of the user;
configuring the image files to specifications prescribed by the user;
generating a presentation viewable from a web page from the image files;
storing the presentation on the server; and
assigning a uniform resource locator for the presentation.

2. The method of claim 1 wherein the presentation is a 3DMovie.

3. The method of claim 1 wherein the presentation is a Virtual Tour.

4. The method of claim 1 wherein the image files are configured to image height specifications selected by the user.

5. The method of claim 4 wherein the image files are configured to consistent sizes.

6. The method of claim 1 further comprising the step of compressing the image files after configuring the image files to the specifications.

7. The method of claim 1 further comprising the step of inserting sequence numbers into each image file.

8. The method of claim 1 further comprising the step of stitching the image files into a panoramic image.

9. The method of claim 1 wherein an unique identification number is generated for the presentation.

10. The method of claim 9 wherein the identification number is used for adding audio files to the presentation.

11. The method of claim 1 further comprising the step of adding narration to the presentation by having the user record audio files that are associated with the presentation.

12. The method of claim 11 wherein the audio files are played when the presentation is played.

13. A system for creating a presentation that is published on the Internet, the system comprising;
a user computer for selecting and uploading image files, and prescribing specifications for the image files by the user; and
a server computer for receiving the image files and configuring the image files to the specifications, the server computer being configured to generate and store a presentation viewable from the image files and assign a uniform resource locator to the presentation.

14. The system of claim 13 wherein the presentation is a 3DMovie.

15. The system of claim 13 wherein the presentation is a Virtual tour.

16. The system of claim 13 wherein the image files are configured to image height specifications selected by the user.

17. The system of claim 16 wherein the image files are configured to consistent sizes.

18. The system of claim 13 wherein the server computer is configured to compress the image files after configuring the image files to the specifications.

19. The system of claim 13 wherein the server computer is configured to insert sequence numbers into each image file.

20. The system of claim 13 wherein the server computer is configured to stitch the image files into a panoramic image.

21. The system of claim 13 wherein the server computer is configured to assign an unique identification number to the presentation.

22. The system of claim 21 wherein the identification number is used for adding audio files to the presentation.

23. The system of claim 13 wherein the server computer is configured to record narration for the presentation by having the user record audio files that are associated with the presentation.

24. The system of claim 23 wherein the server computer is configured to play the audio files when the presentation is played.
